(19) United States
(12) Patent Application Publication
(10) Pub. No.: US 2002/0196832 A1
(43) Pub. Date: Dec. 26, 2002

(54) Method and apparatus for removing acid gases from the exhaust of lasers

(75) Inventor: Benzion Freedman, D.N. Hamovil (IL)

Correspondence Address: MERCHANT & GOULD PC, P.O. BOX 2903, MINNEAPOLIS, MN, 55402-0903, US

(73) Assignee: RAFAEL-ARMAMENT DEVELOPMENT, Haifa (IL)

(21) Appl. No.: 10/134,769

(22) Filed: Apr. 29, 2002

Related U.S. Application Data
(63) Continuation-in-part of application No. 09/516,296, filed on Mar. 1, 2000.

(30) Foreign Application Priority Data
Mar. 4, 1999 (IL) 128838

(51) Int. Cl. H01S 3/22; H01S 3/223; C01B 17/69; C01B 17/70

(52) U.S. Cl. 372/59

(57) ABSTRACT

Method and apparatus for removing acid gases from the exhaust of lasers, which comprises adding to the effluent of the laser generator a reactive, solid, powdery material, consisting in a metal oxide or hydroxide, preferably chosen from among magnesium or calcium oxide or hydroxide, and allowing the effluent to be dispersed in the environment with the reaction products of the metal oxide with the HF/DF gases and with any unreacted amount of the metal oxide. The reactive, powdery material may be fed into laser exhaust plume formed by the laser effluent or into the primary stream which drives the exhaust gases through the ejector. The amount of metal oxides that can be used may be at least stoichiometric with respect to the HF/DF gases.

### FIELD OF THE INVENTION

This invention relates to a method and apparatus for removing acid gases, particularly HF and/or DF, from the exhaust of chemical laser generators.

### BACKGROUND OF THE INVENTION

The gases which result from the reactions in chemical laser generators are discharged into the atmosphere at high temperature and high speed by means of ejectors. They contain considerable amounts of acid gases, specifically HF and/or DF, formed in said reactions, which gases are poisonous and pose a very serious ecological and health hazard. From the chemical viewpoint they have the same behavior, and therefore may be considered together in this description and indicated briefly by HFIDF. Various attempts have been made in the art to deal with the problem posed by such gases.

It has been attempted to remove HFFDF before the laser exhaust gases reach the ejector which discharges them into the atmosphere, by installing before said ejector a scrubber in which they are contacted by a spray of an alkaline solution, which neutralizes the HF/DF and entrains the resulting salts. However such a scrubber, to be effective, must be extremely large and increase the size of the laser generator to an extent that is always undesirable and in many cases totally unacceptable.

The prior art has always attempted to deal with the problem without eliminating HFIDF, by accepting their presence in laser effluent gases.

According to this approach, said gases are ejected in the form of a jet having a very high speed, so that it rises to a height of 50-100 meters and forms a cloud which gradually disperses. It has been calculated that under most weather conditions, this will produce an HF/DF content in the atmosphere that is within admissible limits. This approach, however, is not satisfactory, because it is always undesirable to pollute the environment with poisonous gases even if the pollution is within certain limits, and further, those limits may be exceeded under unfavorable weather conditions: e.g., rain may dissolve the HF/DF gases and cause pollution of the ground.

Another proposal is offered by H. Laeger and R. Cavalleri in a report “Development of a solid fueled scrubber ejection for an HF/DF chemical laser” published by Atlantic Research Corporation as Technical Report AFAL-TR-74-165. It is proposed therein to produce the primary gas stream, necessary to operate the laser ejector system, by seeding the solid propellant fuel with an alkali nitrate, which upon combustion yields alkali atoms and alkali hydroxide gases, which then react with the HF/DF, rendering it less toxic. This proposal involves a departure from the most effective design of laser generators as to the choice of propellant and combustion chamber; and further, it is actually restricted to the use of Li, Na or K as metal, because other metals would cause nozzle clogging or incomplete gas-solid reactions, resulting in significantly toxic fluorides which are emitted, as soluble compounds, into the environment. This proposal is therefore unsatisfactory both from the engineering and from the ecological viewpoint.

It is a purpose of this invention to provide a method and apparatus for the removal of a very substantial portion, or practically all, of HF/DF from laser exhaust gases, which method and apparatus are efficient and overcome all the difficulties with which the art is faced.

It is another purpose of this invention to accomplish said removal without requiring changes in the design of the laser generator.

It is a further purpose of this invention to prevent any pollution of the environment and any danger to persons.

It is a further purpose of this invention to accomplish the removal of HF/DF without increasing the size of the laser generator.

It is a further purpose of this invention to accomplish said removal without producing toxic fluorides.

It is a further purpose of this invention to accomplish said removal without requiring apparatus means that are very expensive or difficult to operate or maintain.

It is a further purpose of this invention to accomplish said removal without causing clogging of nozzles, heat damage of the laser ejector, or other phenomena that can interfere with the regular operation of the laser generator.

It is a further purpose of this invention to accomplish said removal by process and apparatus means that can be fully synchronized with the operation of the laser and therefore are only actuated when a laser beam is being generated.

It is a further purpose of this invention to accomplish said removal by an apparatus that is of limited size and weight and can be utilized in transportable systems, such as, for instance, transportable military systems.

Other purposes and advantages of this invention will appear as the description proceeds.

### SUMMARY OF THE INVENTION

The method according to the invention comprises adding to the effluent of the laser generator a reactive, solid, powdery material, consisting in a metal oxide or hydroxide, preferably chosen from alkali and alkali-earth metal oxides or hydroxides, and more preferably from among magnesium oxide or hydroxide or calcium oxide or hydroxide, and allowing the effluent to be dispersed in: the environment together with the reaction products of said metal oxide or hydroxide with the HF/DF gases and with any unreacted amount of said metal oxide or hydroxide. Oxides and hydroxides of strontium, Na, K and Li while included among alkali and alkali-earth metal oxides or hydroxiudes, but are less preferred than those of calcium and magnesium, and other oxides or hydroxides are even less preferred, because their fluorides have various degrees of toxicity, lower than those of HF/DF, but more or less higher that those of magnesium and calcium fluorides.

The oxides or hydroxides can be fed to the exhaust jet or plume formed by the laser effluent, or can be fed to and become a part of the primary or driving stream which drives the exhaust gases through the ejector. The term “ejector”, as used herein, refers to the main ejector of the laser generator, through which the gases produced in the generation of the laser are ejected into the atmosphere, or to a plurality of such ejectors, if a plurality is provided, and not to any other ejectors that may be included in the laser apparatus for any other purposes.

The amount of metal oxides or hydroxide used is at least stoichiometric with respect to the HF/DF gases and preferably higher than stoichiometric, e. g. 1.5 times or more. Since the neutralization of the HF/DF, according to the invention, is a heterogeneous, solid-gas reaction, the contact surface, which is the surface of the metal oxide powders, should be as high as possible. For this purpose, preferably, the surface density of the powders should be as high as possible and their grain size should be as small as possible. Non-limitative examples are surface densities of about 200 sq.m/gr or more and grain sizes of about 6 micron. As a further example, Ca(OH)₂ can be produced from CaO (which is industrially produced by the sintering of limestone) by reaction with water, to give a fine dispersed powder, which powder has a bulk density of about 400 kg/m³ and an average particle size of about 4 to 8 micron.

The metal oxide powders may be fed to the laser effluent, at the desired point, by any convenient means, e.g. mechanical or pneumatic means. Adequate mechanical means are generally known in the art and need not be particularly described For instance, a powder container may be provided at its bottom with an outlet in which is fitted a dispenser, e.g. a rotary powder or a short extruder, which can be actuated at the appropriate moment and controlled to supply powder at the desired rate. The effluent gases, flow past such a dispenser at high speed, will contribute a powder entraining and dispersing action.

Pneumatic means, on the other hand, require that large amounts of powder entraining gas be supplied at high pressure. They can be supplied by pneumatic devices, such as blowers, well known to skilled persons, and this option is included in the invention. Pneumatic and mechanical means may be combined. Another way of supplying entraining gas is by combustion of a solid or liquid fuel. A further way, which will be particularly described by way of illustration, comprises catalytically decomposing a solid or, more preferably, liquid substance, that will be called herein “propellant”. The preferred propellant is hydrogen peroxide, which undergoes exothermic catalytic decomposition into water, which vaporizes, and oxygen, producing what will be called hereinafter “propellant stream”. The vessel, in which the catalyst is contained and the decomposition occurs, will be called “gas generator”. The temperature of the propellant stream may be controlled as desired. For instance, the presence of oxygen permits, if desired, to raise said temperature by passing the stream through a burner and burning therein a fuel. The solid content of the propellant stream should be from 5 to 20 kg/m³, e.g. 15 kg/m³. Further, the metal oxide/hydroxide carrying propellant stream may be joined to the aforesaid primary or driving stream, or said propellant stream may constitute itself the primary or driving stream. In these cases, the reaction between the reactive powder and the HF/DF gases, contained in the secondary flow resulting from the laser generation reactions, begins before or in the final ejector. If the metal oxide/hydroxide carrying stream is fed to the effluent jet of the ejector, or exhaust plume, said reaction begins as soon as said stream is mixed with said plume, and, under the conditions hereinbefore set forth, takes place in said plume in a very short time.

In any case, the exhaust plume is allowed to disperse into the atmosphere. It contains no toxic substances and constitutes no ecological hazard or damage, and additionally, it is not ejected continuously, but only intermittently, during the limited periods of operation of the laser.

The apparatus according to the invention comprises, in addition to the prior art laser generator: a reactive powder (metal oxide/hydroxide) reservoir, and a powder feeding device for feeding the powder into the laser effluent. The feeding device may be e.g.; 1) a dispenser fitted or operatively connected to the reservoir, optionally with guide means for directing the dispensed powder to the desired zone of the effluent stream; 2) a combustion device and conduit means for receiving fuel from a reservoir, on the one hand, and for leading the combustion gases to the desired zone of the effluent stream, on the other, and means for feeding reactive powder to said combustion gases; 3) a reservoir of a propellant, preferably a liquid propellant, a gas generator for generating a propellant gas stream, means for feeding reactive powder to said stream, and the required conduit connections; 4) compressor or blower means and means for feeding reactive powder to the compressed air stream produced by them; or 5) a combination of two or more of such means. The operation of these components is synchronized with the activation of the laser generator, and the apparatus comprises the necessary synchronizing means, which need not be described as they are readily provided by persons skilled in the art.

### BRIEF DESCRIPTION OF THE DRAWINGS

In the drawings:

FIGS. 1 to 5 are block illustrations of several embodiments of the invention and FIG. 6 illustrates schematically a reactor.

### DETAILED DESCRIPTION OF PREFERRED EMBODIMENTS

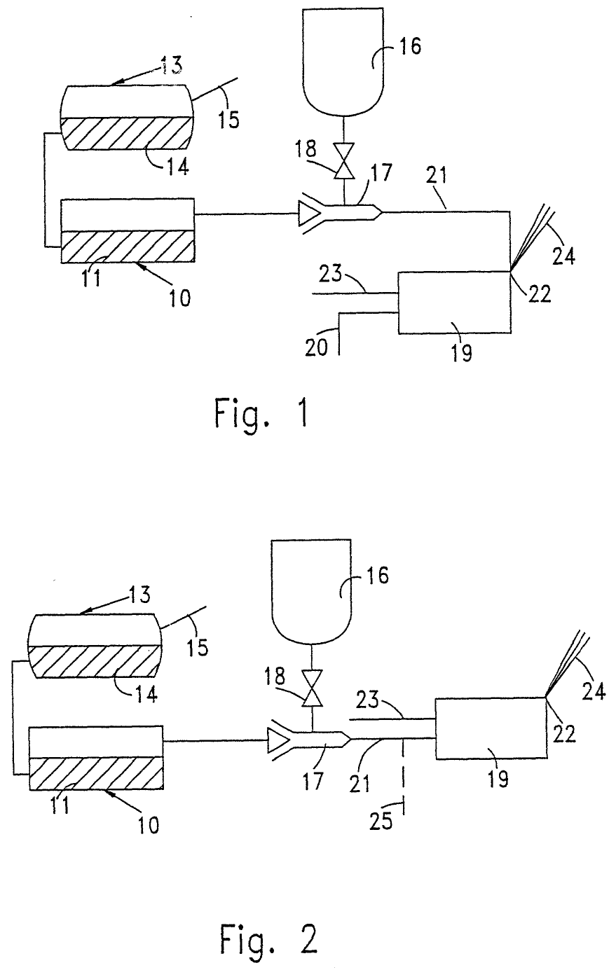

With reference now to FIG. 1, numeral 10 designates a gas generator, which produces gas at pressure from 40 to 15 bar, in this embodiment 35 bar, at a temperature from 900 to 450° K., in this embodiment about 540° K. The gas generator 10 contains a catalytic bed 11, consisting for instance of silver wires. The gas generators of this type, per se, are known apparatus in the laser industry and do not require detailed description herein.

A liquid propellant, preferably H₂O ₂, indicated at 14, is contained in a tank 13 and fed to gas generator 10 and through the catalytic bed 11, by gas pressure produced by any convenient means, not illustrated, and applied to the surface of propellant 14 as schematically indicated at 15. The reactive powder, stored in storage reservoir 16, is constituted by MgO—Mg(OH)₂ or CaO—Ca(OH)₂. The steam and oxygen mixture, produced by catalytic decomposition of the propellant in gas generator 10, is fed as entraining gas to a nozzle 17 and draws and entrains the powder from reservoir 16 when valve 18 is open. In an alternative embodiment, a common air compressor, not illustrated, can replace said gas generator.

Main ejector 19 of the laser apparatus receive a primary gas stream 20, produced by any known means as in prior art laser generators and not illustrated, which drives a secondary stream 23 of gases generated in the laser generator, not illustrated, and containing HF/DF. The propellant stream 21, with the entrained reactive, alkali metal or alkali-earth metal oxide or hydroxide powder, is fed through a suitable nozzle at 22 to the effluent or exhaust plume 24, issuing from ejector 19, and mixes and reacts with it.

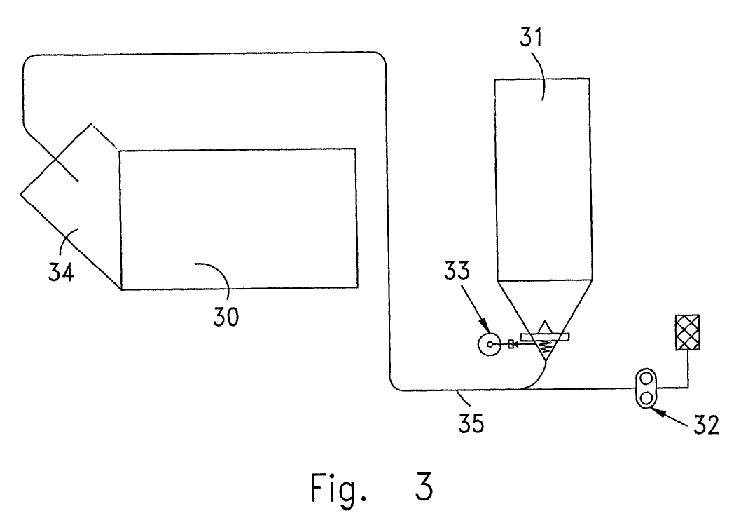

FIG. 2 schematically illustrates in the same manner as FIG. 1 a second embodiment of the invention. The same component as those of FIG. 1 are indicated by the same numerals. This embodiment differs from the previous one in that the propellant stream, carrying the alkali metal or alkali-earth metal oxide or hydroxide powder, constitutes the primary or driving stream of the ejector 19, and therefore the reaction of the powder with the HF/DF gas begins within the injector.

In an alternative of this embodiment, an additional primary stream 25, indicated in broken lines in FIG. 2 is joined to the propellant stream to constitute a composite driving injector stream.

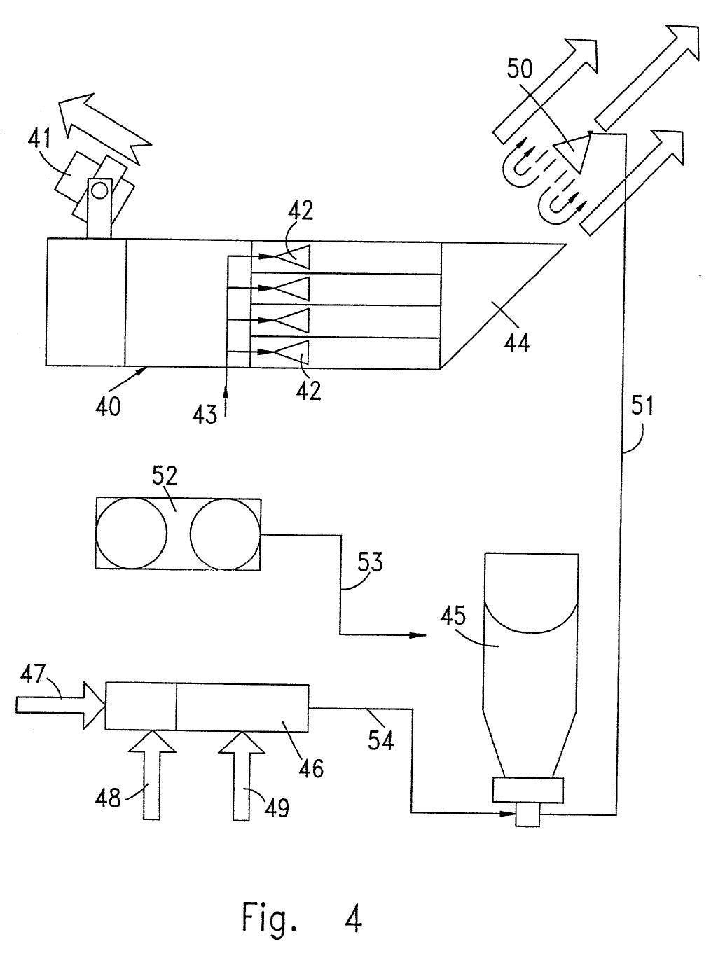

FIG. 3 schematically shows an embodiment in which an air compressor replaces the gas generator. The laser apparatus is generally indicated at 30. 31 is a reservoir containing the alkali metal or alkali-earth oxide or hydroxide powder. 32 generally indicates a compressor or blower. Compressed air is fed through line 35, entrains powder, which is released in the required amount by a deser equipment generally indicated at 33, and the stream of air and powder is discharged into the exhaust plume of the laser at 34.

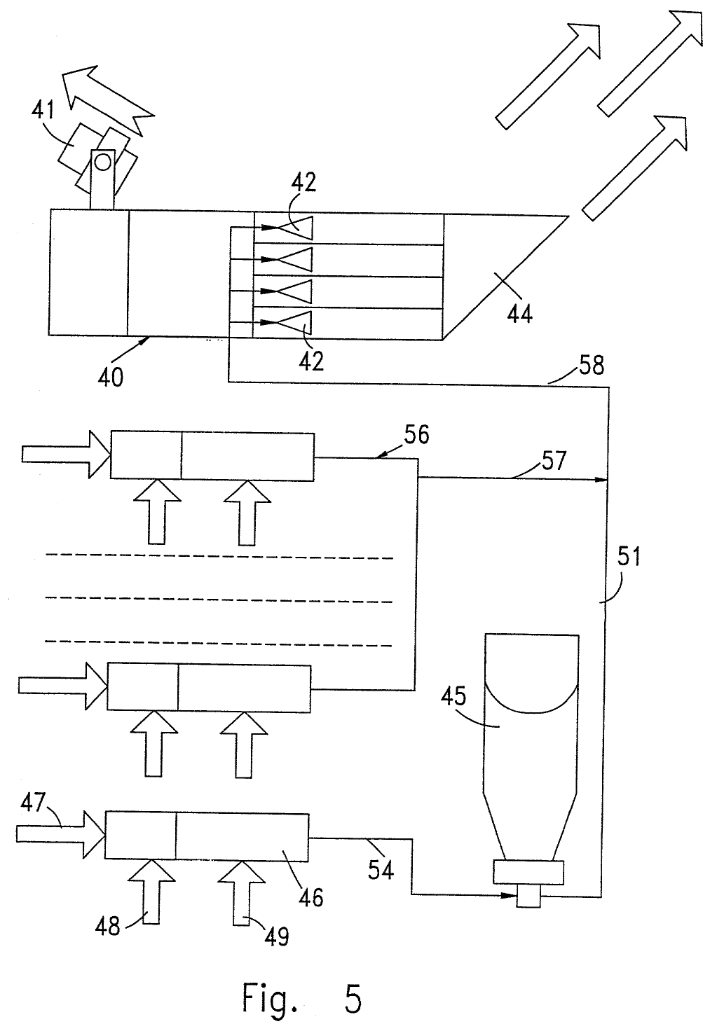

FIG. 4 schematically shows still another embodiment, essentially similar to that of FIG. 1. The laser generator is generally indicated in this figure at 40 and the laser beam is emitted at 41. 42 are the ejectors of the laser, to which gas from a gas generator is fed at 43. The gas generator for producing powder entraining is shown at 46, and will generally not be the same that produces the primary stream of the ejectors. Hydrogen peroxide is fed to generator 46 at 47, fuel at 48 and water at 49. 45 is the reservoir containing alkali metal or earth-alkali metal oxide or hydroxide powder. The gas from generator 46 flows through line 54, entrains the powder, and the air-powder mixture flows through line 51 and reaches the powder dispersion nozzles 50, which disperse it into the laser exhaust plume emitted by exhaust 44. In an alternative, an air compressor 52 can be used in place of gas generator 46, and line 53 take the place of line 54, everything else being equal.

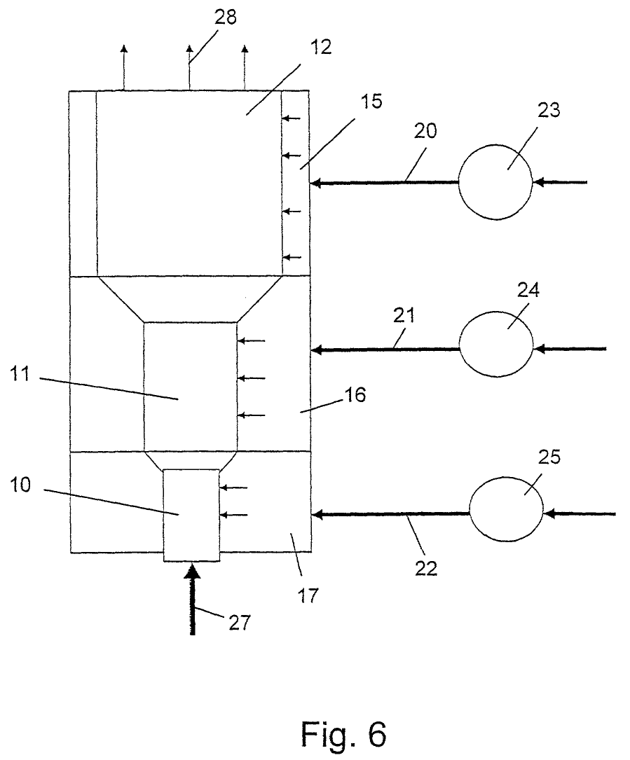

FIG. 5 schematically shows a further embodiment, in which the propellant stream is joined to the main primary stream. Laser generator 40, laser beam emitter 41, ejectors 42, laser exhaust 44, powder tank 45, gas generator 46 and line 54 are the like those indicated in FIG. 4 by the same numerals. However, in this embodiment, a further gas generator equipment 56, comprising several units each of which is a generator 46, generates a stream which flows through line 57 and is joined to the powder entraining stream flowing through line 51, producing a combined primary stream which is fed through line 58 to the ejectors. In this embodiment, therefore, the stream entraining the alkali metal or earth-alkaline metal oxide or hydroxide powder becomes part of the primary or driving stream of the laser ejectors and is fed to the laser exhaust gas upstream of its issuing to the environment as exhaust plume.

In order to simulate the conditions obtaining in a cloud freely formed in the atmosphere, a reactor is provided as shown in FIG. 6. 10, 11 and 12 are sections of the reactor of increasing diameter. 15, 16 and 17 are corresponding jacket sections. 20, 21 and 22 indicate feeds of atmospheric air to the various reactor sections, the rate of the several feeds being measured by flow meters 23, 24 and 25. The walls of the reactor are perforated to introduce from the jackets into the reactor sections atmospheric air (that can be dried or humidified, if desired). The feed of the air to the jackets, and therefore to the reactor, is controlled to achieved a desired composition of the gaseous stream in the reactor. The laser effluent is introduced into reactor section 10, as indicated at 27, and proceeds successively through the other sections, finally issuing from the reactor as indicated at 28. The hydraulic resistance of the perforated walls is sufficiently high to prevent penetration of Laser effluent containing HF/DF into the jackets. Instead of being perforated, the reactor walls could be made of porous material. The increasing diameter of the reactor sections simulates the dispersion of the effluent in open atmosphere. The behavior of a laser effluent treated in this reactor is therefore essentially the same as the behavior in a free cloud.

### Example 1 (comparative)

In this example no oxide or hydroxide is used, viz. this example represents the prior art. The laser effluent gas is mixed with steam used as a propellant stream. The composition of the resulting mixture is: HF/DF mixture 9 kg; H₂ O 165 kg; insert gas 36 kg; CO₂ 56 kg. It can be expressed in arbitrary units, which are kg of compound per kg of HF/DF mixture, {kg/kg}. If so expressed, said composition is: HF and DF 1 kg/kg; H₂O 18.3 kg/kg; inert gases 4 kg/kg; CO₂ 6.3 kg/kg. The concentration (average) of HF and DF in the cloud after 30 seconds is 429 mg/m³.

### Example 2

The composition of laser effluent gas mixed with steam from the ejector is the same as in Example 1. The invention is carried out according to the embodiment of FIG. 1. Fine dispersed Ca(OH)₂ with the average size of particles about 6 microns is introduced into the laser effluent gas stream after the injector, which has the aforesaid composition. The concentration of HF and DF in the cloud after 30 seconds, as function of amount of Ca(OH)₂{kg/kg} introduced, is given in the following table.

TABLE I
Concentration of HF + DF in the cloud after 30 seconds as function of
Ca(OH)₂ introduced

| | Concentration of HF |
|---|---|
| Amount of Ca(OH)₂ (kg) | mg/cubic meter |
| 16.5 | 237 |
| 30 | 149 |
| 60 | 46 |
| 90 | 12 |

The calcium hydroxide reacts with CO₂ as follows: Ca(OH)₂+CO₂=CaCO₃+H₂O. Concurrently it reacts with HF/DF as follows: CaCO₃+2HF=CaF₂+CO₂. Therefore, the reaction of Ca(OH)₂ with CO₂ does not prevent neutralization of HF/DF.

### Example 3 (Comparative)

In order to simulate the conditions obtaining in a cloud freely formed in the atmosphere, a reactor was provided as shown in FIG. 6. The components of the effluent were mixed and entered the said reactor, whereafter essentially the same phenomena occurred as if said components were dispersed in a cloud. The gaseous flow along the reactor increased due to penetration in the reactor of atmospheric air (as takes place in a cloud). The concentration of HF/DF decreased due to dilution of the flow with atmospheric air.

A laser effluent, mixed with steam from the laser ejector, contained HF/DF mixture, H₂O, inert gases, and CO₂. The weight ratios of the said components, taking the amount of HF/DF as 1, were: 1:18.3:4:6.2. The initial amounts of components introduced into the reactor were HF/DF 9.2 gr; H₂O 165 gr; inert gas 36 gr; CO₂ 56 gr.

The final concentration of HF/DF in gaseous flow was determined in the outlet 28 from the reactor. The concentration at residence time 30 sec was 441 mg/m³.

### Example 4

The composition of laser effluent gas mixed with steam from the ejector was the same as that of Example 3.

Fine dispersed Ca(OH)₂ with an average particle size of 6 microns was introduced into laser effluent gas stream (after the injector). The concentration of HF/DF in the cloud after 30 seconds, as function of the amount of Ca(OH)₂ introduced, is given in Table II.

TABLE II
Concentrations of HF + DF in the cloud
after 30 seconds as function of the
amount of Ca(OH)₂ introduced

| Amount of Ca(OH)₂ | Concentration of HF/DF |
|---|---|
| (gr) | (mg/m³) |
| 16.5 | 257 |
| 30 | 135 |
| 60 | 42 |
| 90 | 10 |

The decrease of the HF/DF concentration in the reactor, which simulates a cloud, after 30 seconds is due to the reaction with the powdery reagent and to the dilution with atmospheric air.

### Example 5

The composition of gaseousous and vapor stream after ejector and method for introduction of powdery reactant to the stream were the same as in Example 4. The powery reactant was fine dispersed powder of calcium oxide CaO. The stoichiometric ratios of CaO regarding the HF/DF mixture are the same as in the case of Ca(OH)₂. The concentration of HF/DF in the cloud after 30 seconds, as function of the amount of CaO introduced is given Table III.

TABLE III
Concentration of HF + DF in the cloud after 30 seconds as function of
the amount of CaO introduced

| | Concentration of HF/DF |
|---|---|
| Amount of Ca(O) (gr) | (mg/m³) |
| 12.5 | 320 |
| 22.7 | 205 |
| 45.4 | 62 |
| 68 | 18 |

Some disorder of the results takes place when CaO is used, because CaO is hydrolyxed by atmospheric water to produce Ca(OH)₂.

### Example 6

The composition of gaseous and vapor stream after ejector and method for introduction to the stream of powdery reactant were the same as in Example 4. The powdery reactant was fine dispersed powder of magnesium oxide, MgO. The concentration of HF/DF in the cloud after 30 seconds as function of the amount of MgO introduced is given in Table IV.

TABLE IV
Concentrations of HF + DF in the cloud after 30 seconds as function of
the amount of MgO introduced

| | Concentration of HF/DF |
|---|---|
| Amount of MgO (gr) | (mg/m³) |
| 9 | 405 |
| 16.3 | 328 |
| 33 | 210 |
| 49 | 93 |

### Example 7

This is similar to Example 6, but the powdery reactant is magnesium hydroxide, Mg(OH)₂. The results are given in Table V.

TABLE V
Concentrations of HF + DF in the cloud after 30 seconds as function of
the amount of Mg(OH)₂ introduced

| | Concentration of HF/DF |
|---|---|
| Amount of Mg(OH)₂ (gr) | [mg/m³] |
| 13.4 | 294 |
| 24.4 | 185 |
| 48.9 | 76 |
| 73.3 | 38 |

### Example 8

The laser effluent, before mixing with steam from the ejector, contained HF/DF mixture, H₂O, inert gases, and CO₂. The final composition of the gaseous mixture is as in Example 4. The weight ratios of the mixture components, taking the amount of HF/DF as unit, were: 1:2.4:4:6.2. The weight ratios of the gaseous mixture after the injector were: 1:18.3:4:6.2. The amount of steam introduced as propellant is 12 wt % of the total amount. Powdery reagents are introduced before the injector. The experiments were carried out using as powdery reagents Ca(OH)₂, CaO, Mg(OH)₂ and MgO. The amount of powdery reagent in all experiments was 2.6 moles per mole of HF/DF mixture. The results are given in Table VI.

TABLE VI
Concentrations of HF + DF in the cloud after 30 seconds in the case of
introduction of powdery reagent before injector (embodiment 2)

| | | Concentration of HF/I |
|---|---|---|
| Powdery reagent | Amount of reagent (gr) | mg/cubic meter |
| Ca(OH)₂ | 9 | 13 |
| CaO | 6.8 | 16 |
| Mg(OH)₂ | 73.3 | 40 |
| MgO | 49 | 89 |

It is seen that Ca(OH)₂ has advantages over the said other powdery reagents. The advantages include:

1. It is the most inexpensive.

2. Fine dispersed Ca(OH)₂ can be produced by reaction crumbs of CaO with water without any grinding.

The numerous oxides, hydroxides, carbonates, chlorides of alkali metals and others can be used as powdery reactants. Thus, for example, these reactants can be A1₂O₃, fine dispersed SiO₂, CaCl, CaCO₃ and NaOH. The final products are suitable fluorides. However, only fluorides of magnesium and calcium are practically insoluble (solubility in water is 7-8 mg/liter). Solubility of other fluorides is 10-1000 times more than the solubility of MgF₂ and CaF₂. Therefore, MgF₂ and CaF₂ are non-hazardous compounds. The other fluorides are more or less hazardous. However, the toxicity of fluorides is less than the toxicity of HF. Therefore, the use of oxides or hydroxides, other than oxides and hydroxide calcium and magnesium as the powdery reactant, is not excluded in principle.

The difference between the two methods hereinbefore described of the introduction of powdery reactants into the laser effluent is small. The choice of the method depends on technical details.

While embodiments of the invention have been described by way of illustration, it will be apparent that the invention can be carried out with many modifications, variations and adaptations, without departing from its spirit or exceeding the scope of the claims.

1. Method for removing acid gases from the exhaust of lasers, which comprises adding to the effluent of the laser generator a reactive, powdery material, comprising a compound chosen in the group consisting of oxides and hydroxides of metals, allowing said reactive, powdery material to react with said acid gases and allowing said effluent to be dispersed in the environment with the products of the reaction of said metal oxide or hydroxide with said acid gases and with any unreacted amount of said metal oxide or hydroxide.

2. Method for removing acid gases from the exhaust of lasers, which comprises adding to the effluent of the laser generator a reactive, powdery material, comprising a compound chosen in the group consisting of oxides and hydroxides of alkali and earth-alkali metals, allowing said reactive, powdery material to react with said acid gases and allowing said effluent to be dispersed in the environment with the products of the reaction of said metal oxide or hydroxide with said acid gases and with any unreacted amount of said metal oxide or hydroxide.

3. Method for removing acid gases from the exhaust of lasers, which comprises adding to the effluent of the laser generator a reactive, powdery material, comprising a compound chosen in the group consisting of magnesium oxide, magnesium hydroxide, calcium oxide and calcium hydroxide, allowing said reactive, powdery material to react with said acid gases and allowing said effluent to be dispersed in the environment with the products of the reaction of said metal oxide or hydroxide with said acid gases and with any unreacted amount of said metal oxide or hydroxide.

4. Method according to claim 1, wherein the acid gases comprise at least a gas chosen from HF and DF.

5. Method according to claim 1, wherein the reactive, powdery material is fed into laser exhaust plume formed by the laser effluent.

6. Method according to claim 1, wherein the reactive, powdery material is fed into a primary stream which drives the exhaust gases through an ejector.

7. Method according to claim 1, wherein the amount of metal oxides used is at least stoichiometric with respect to the HF/DF gases.

8. Method according to claim 1, wherein the surface density of the reactive, powdery material is as high as possible and the grain size is as small as possible.

9. Method according to claim 1, wherein the reactive, powdery material is fed to the laser effluent, at the desired point, by mechanical means.

10. Method according to claim 9, wherein the mechanical means comprise means for dispensing the powders from a powder container.

11. Method according to claim 1, wherein the reactive, powdery material is fed to the laser effluent, at the desired point, by pneumatic means.

12. Method according to claim 11, wherein the pneumatic means comprise a powder entraining gas stream.

13. Method according to claim 12, wherein the powder entraining gas stream is produced by an air compressor.

14. Method according to claim 12, wherein the powder entraining gas stream is produced by catalytically decomposing a propellant to generate a propellant stream.

15. Method according to claim 14, wherein the propellant is hydrogen peroxide.

16. Method according to claim 1, wherein the reactive, powdery material is fed to the laser effluent, at the desired point, by a combination of pneumatic and mechanical means.

17. Method according to claim 12, wherein the powder entraining gas stream constitutes itself the primary stream of the laser ejector.

18. Method according to claim 2, wherein the reactive, powdery material is calcium hydroxide having particle size prevalently in the range from 4 to 8 microns and bulk density about 400 kg/m³, produced by sintering limestone and reacting the sintered material with water,

19. Apparatus for removing acid gases from the exhaust of lasers, which comprises a reactive powder reservoir and a powder feeding device for feeding the powder into the laser effluent.

20. Apparatus according to claim 19, wherein the feeding device comprises a dispenser operatively connected to the reservoir.

21. Apparatus according to claim 19, wherein the feeding device comprises an apparatus for generating a powder entraining gas stream.

22. Apparatus according to claim 21, wherein the feeding device comprises a combustion device and conduit means for receiving fuel from a reservoir, on the one hand, and for leading the combustion gases to the desired zone of the effluent stream, on the other, and means for feeding reactive, powdery material to said combustion gases.

23. Apparatus according to claim 19, wherein the feeding device comprises a reservoir of a propellant, a gas generator for generating a propellant gas stream, means for feeding reactive, powdery material to said stream, and conduit connections.

24. Apparatus according to claim 19, wherein the feeding means comprise entraining nozzle means for drawing reactive, powdery material from the reactive powder reservoir.

25. Apparatus according to claim 23, wherein the conduit connections comprise a conduit provided with a nozzle for leading and discharging the powder entraining stream into the exhaust of the laser ejector.

26. Apparatus according to claim 23, wherein the conduit connections comprise a conduit provided with a nozzle for leading the propellant stream carrying the reactive, powdery material as driving stream to the laser ejector.

27. Apparatus according to claim 23, wherein the conduit connections comprise a conduit for joining a driving stream to the propellant stream before leading the resulting composite stream as a driving stream to the ejector.

28. Apparatus according to claim 19, comprising means for synchronizing it with the activation of the laser generator.
